(19) United States
(12) Patent Application Publication
(10) Pub. No.: US 2012/0221362 A1
(43) Pub. Date: Aug. 30, 2012

(54) System and method for managing group ticket procurement

(76) Inventors: Ohad Nezer, Houston, TX (US); Tamir Dagan, Tel Aviv (IL); Christoffer Paul Nicolaysen, Houston, TX (US)

(21) Appl. No.: 12/932,365

(22) Filed: Feb. 24, 2011

(51) Int. Cl. G06Q 10/00

(52) U.S. Cl. 705/5

(57) ABSTRACT

The present invention is a business method that is a process for coordinating the sale of tickets to groups of people who want to sit together at the event, but pay for their tickets separately. Specifically, the invention is a method of providing group tickets to an event of interest, comprising selecting an event of interest; screening an inventory of seats for the event to create a list of available tickets; choosing from the list, tickets that meet a set of predetermined criteria; and processing the purchase of one or more group tickets by each group member, using information supplied by said group member.

### BACKGROUND OF THE INVENTION

1. Field of the Invention

The present invention relates in general to the field of systems and methods for managing procurement of tickets for events. More specifically, the present invention relates to systems and methods for managing procurement of group tickets for events.

2. Description of the Related Art

It is challenging to coordinate a group of people to attend a public outing such as a professional sports event, concert, or theater show when one does not necessarily want to pay for all the group members who attend the event. Coordinating who will pay for the tickets and how the individual who purchases the tickets will be reimbursed is often inconvenient.

TicketMaster, StubHub, Ticket Network and other providers in the primary and secondary market, provide platforms for event attendees to search for an event and then view ticket availability for that event. Once the desired tickets are found, users proceed to purchase electronically using a credit card, e-check, or paypal account. The tickets are then shipped to their address. For a group wishing to attend an event together, the only way currently to ensure that all the seats are adjacent to one another is to purchase them all in one transaction, and have the tickets sent to one location.

Evite, Socializr and similar sites provide a mechanism for creating an electronic record of an event, delivering invitations via email, and then managing the responses to those invitations. The mechanism is not event-type specific (other than aesthetics of themed “wallpaper” and images) and can be used for everything from a sightseeing tour of the moon to a family member's birthday party.

WePay is a new service with a similar feel to PayPal. The main difference between PayPal and WePay is that WePay offers a toolset geared toward managing group funds. This type of service potentially could be used by an event organizer to collect money from each person in a group wishing to attend a live event together. While WePay offers a mechanism by which money could be collected, the burden of final ticket selection, imposing deadlines on group members to pay, shipping, and the managing of invitations and RSVPs would still fall on the organizer.

United States Patent Application 20090063206 describes a system that enables customers to search for event tickets for purchase. A computer interacts with the user to allow the user to specify criteria for event tickets the user wishes to purchase. The system presents relevant event ticket results, and provides filters for the user to further refine those search results. The user selects an event, and then selects tickets for that event. Ticket availability is shown, with seat locations indicated directly on an interactive venue map. For purchase, the user is directed to the selling ticket provider.

United States Patent Application Publication No. 20080255889 discloses a system and a method for selecting tickets on-line according to one or more parameters by the user. Optionally and preferably, the user is also able to purchase the tickets on-line as well. According to preferred embodiments of the present invention, the user may optionally and preferably search on-line for a ticket according to a plurality of parameters, including but not limited to, price, dates/times, exact show, type of show and/or type of seat.

United States Patent Application Publication No. 20100153142 discloses a method for participating in a group decision about purchasing tickets for an event, each person in the group having access to a personal communication device, the method comprising: selecting one person in the group to be in control; initiating a data session with others in the group; accessing, by a personal communication device of the person in control, a seller of tickets for the event; sending, by the personal communication device of the person in control to others in the group, a proposed seating arrangement; receiving, by the personal communication device of the person in control, responses about the proposed seating arrangement from others in the group; and based, at least in part, on the received responses, purchasing tickets for the event.

Thus, there is a need in the art for a business method that can coordinate the sale of tickets to groups of people who, among other things, want to sit together at the event, but pay for their tickets separately. The present invention fulfils this longstanding need in the art.

### SUMMARY OF THE INVENTION

In one embodiment of the present invention, there is provided a business method that is primarily a process for coordinating the sale of tickets to groups of people who want to sit together at an event, but pay for their tickets separately. More specifically, the present invention is directed to a method of providing group tickets to an event of interest, the method comprising selecting an event of interest; screening an inventory of seats for the event to create a list of available tickets; choosing from the list, tickets that meet a set of predetermined criteria; and processing the purchase of one or more group tickets by each group member, using information supplied by the group member.

In another embodiment of the present invention, there is provided a system for providing group-tickets to an event of interest, comprising: a processor; a port coupled to the processor; a memory, coupled to the processor, storing instructions adapted to be executed by the processor to: selecting an event of interest; screening an inventory of seats for the event to create a list of available tickets; choosing from the list, tickets that meet a set of predetermined criteria; and processing the purchase of one or more group tickets by each group member, using information supplied by the group member.

The present invention is further drawn to a computer-readable medium that stores instructions for providing group-tickets to an event of interest, the instructions adapted to be executed by a processor to perform the steps of: selecting an event of interest; screening an inventory of seats for the event to create a list of available tickets; choosing from the list, tickets that meet a set of predetermined criteria; and processing the purchase of one or more group tickets by each group member, using information supplied by the group member.

Other and further aspects, features, benefits, and advantages of the present invention will be apparent from the following description of the presently preferred embodiments of the invention given for the purpose of disclosure.

### BRIEF DESCRIPTION OF THE FIGURES

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIGS. 1A-1B are a flow chart depicting the group ticket purchasing process.

FIG. 2 shows a representative webpage 200 configured for a representative search of an event by the group leader.

FIG. 3 shows a representative webpage 300 configured for entering the event details for an event of interest.

FIG. 4 shows a representative webpage 400 configured for selecting the different ticket criteria accessible to the group leader.

FIG. 5 shows a representative webpage 500 configured for authorizing payment for tickets selected by the group leader.

FIG. 6 shows a representative webpage 600 configured for authoring and sending emails to potential group members.

### DETAILED DESCRIPTION OF THE INVENTION

As used herein the specification, “a” or “an” may mean one or more. As used herein in the claim(s), when used in conjunction with the word “comprising”, the words “a” or “an” may mean one or more than one. As used herein “another” or “other” may mean at least a second or more of the same or different claim element or components thereof. Similarly, the word “or” is intended to include “and” unless the context clearly indicates otherwise. “Comprise” means “include.” Although methods and materials similar or equivalents to those described herein can be used in the practice or testing of the present disclosure, suitable methods and materials are described below. In case of conflict, the present specification, including explanations of terms, will control. In addition, the materials, methods, and examples are illustrative only and not intended to be limiting. Furthermore, unless otherwise required by context, singular terms shall include pluralities and plural terms shall include the singular.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The instant invention comprises business methods, including primarily a process for coordinating the sale of tickets to groups of people who want to sit together at the event, but pay for their tickets separately. Specifically, the present invention is directed to a method of providing group tickets to an event of interest, this method comprising selecting an event of interest; screening an inventory of seats for the event to create a list of available tickets; choosing from the list, tickets that meet a set of predetermined criteria; and processing the purchase of one or more group tickets by each group member, using information supplied by the group member.

In certain embodiments of the instant invention, the predetermined criteria are a smallest and largest acceptable group size. In certain other embodiments, this predetermined criteria is a maximum acceptable price of each ticket in the group. In preferred embodiments, the maximum acceptable price is inclusive of broker fees and shipping costs.

In certain embodiments of the instant invention, the predetermined criteria is a specified lowest acceptable value parameter for each ticket. In preferred embodiments, this value parameter is a number between 1 and 10, such that a value parameter of 10 depicts the highest expected enjoyment value based on the price of the ticket, the nature of the event and spatial relationship of the seat to the event, e.g., to the center of the stage or playing field, etc.

In preferred embodiments, a group leader assigns the predetermined criteria described supra. In certain embodiments, the group leader further assigns an attitude toward the shipping method and the ticket purchase based on minimizing cost or maximizing convenience. In preferred embodiments, the group membership is restricted and only accessible to individuals invited by a group leader.

In certain embodiments of the instant invention, the group tickets are assigned seats adjacent to one another. In certain other embodiments, the group tickets are assigned seats that may not be adjacent to each other, but are nevertheless in the same geographical vicinity.

In certain embodiments of the instant invention, the billing and shipping information provided by the user is encrypted. In preferred embodiments, group tickets are shipped to individual group members. In other embodiments, group-tickets are shipped to a group leader.

The instant invention is also drawn to a system for providing group-tickets to an event of interest. In preferred embodiments, this system comprises a processor; a port coupled to the processor; a memory, coupled to the processor and storing instructions adapted to be executed by the processor to: selecting an event of interest; screening an inventory of seats for the event to create a list of available tickets; choosing from the list, tickets that meet a set of predetermined criteria; and processing the purchase of one or more group tickets by each group member, using information supplied by said group member.

In certain preferred embodiments of the system described supra, the predetermined criteria are: a smallest and largest acceptable group size; a maximum acceptable price of each ticket in the group; and a specified lowest acceptable value parameter for each ticket. In preferred embodiments, the value parameter is a number between 1 and 10, such that a value parameter of 10 depicts the highest expected enjoyment value based on the price of the ticket and the nature of the event.

The instant invention is also drawn to a computer-readable medium that stores instructions for providing group-tickets to an event of interest. The instructions are adapted to be executed by a processor to perform the steps of: selecting an event of interest; screening an inventory of seats for the event to create a list of available tickets; choosing from the list, tickets that meet a set of predetermined criteria; and processing the purchase of one or more group tickets by each group member, using information supplied by the group member.

In certain embodiments of the computer-readable medium described supra, the predetermined criteria are: a smallest and largest acceptable group size; a maximum acceptable price of each ticket in the group; and a specified lowest acceptable value parameter for each ticket. In preferred embodiments, the value parameter is a number between 1 and 10, such that a value parameter of 10 depicts the highest expected enjoyment value based on the price of the ticket and the nature of the event and spatial relationship of the seat to the event, e.g., to the center of the stage or playing field, etc.

The present invention discloses a business method utilizing a consumer process for coordinating the sale of tickets to groups of people who want to sit together at the event, but who pay for their tickets separately. This method could be applied to many different types of e-commerce websites and electronic applications known in the art. These include: (1) Applications for mobile devices (iPhone, Android, WebOS, Windows Mobile, PalmPre, etc); (2) Ticket broker websites (TicketNetwork.com, TicketLiquidator.com, etc); (3) Marketplace websites (StubHub.com, RazorGator.com, eBay.com, etc); (4) Primary Ticket websites (TicketMaster.com, LiveNation.com, etc); (5) Price comparison websites (FanSnap.com, SeatGeek.com, SeatKarma.com, etc); (6) Social Networking websites (Facebook, MySpace, etc); (7) Other General Retail e-commerce (Walmart.com, Amazon.com, etc) and (8) Event Sites (evite.com, socializr.com, etc). The consumer process is best described with reference to the figures.

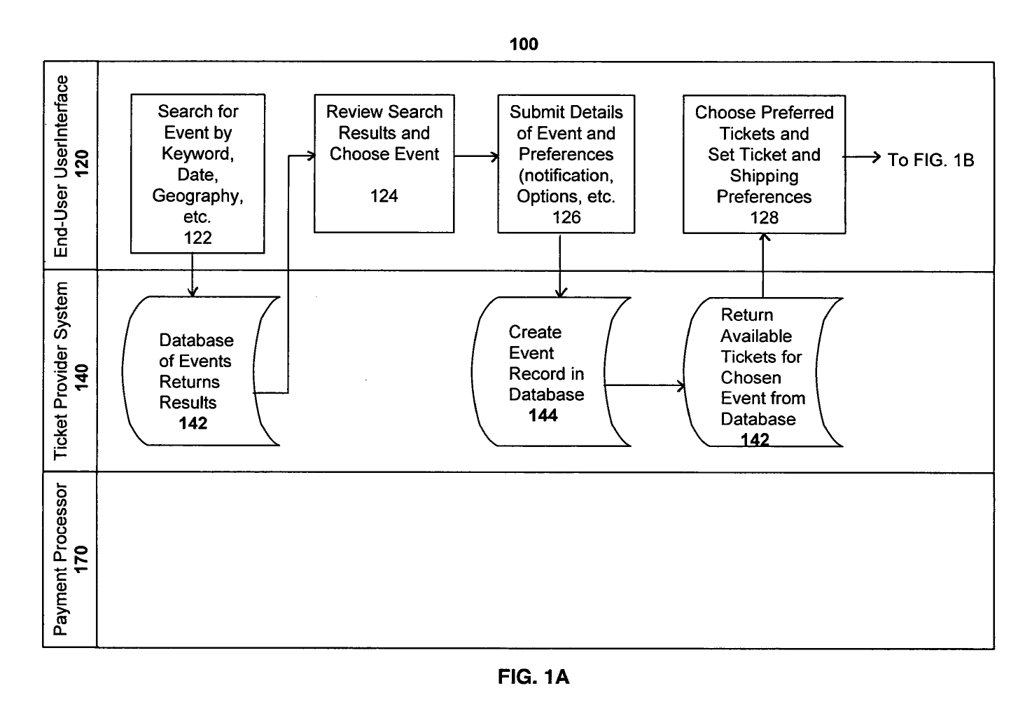

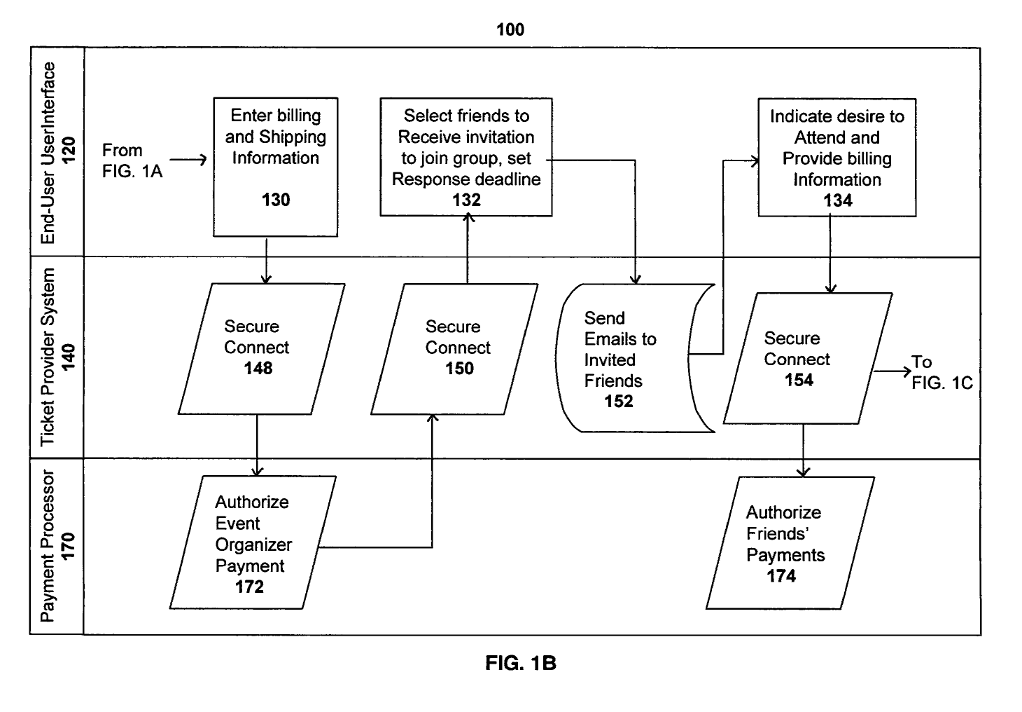

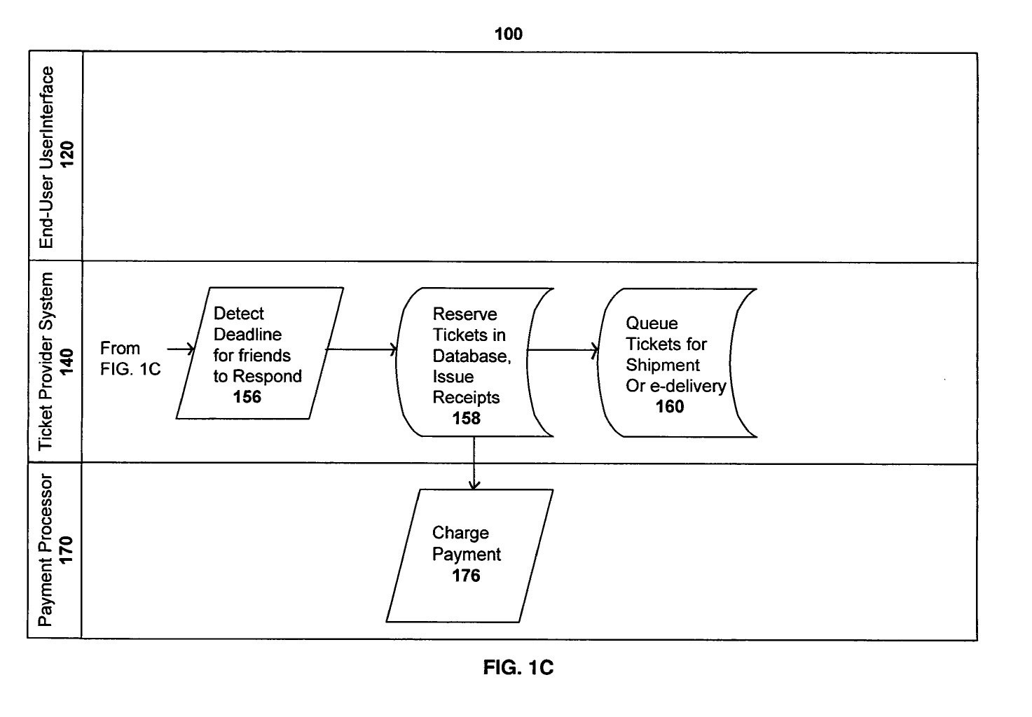

FIGS. 1A-1B depict a flow chart depicting the group ticket purchasing process 100. The process comprises three levels, an end-user user interface 120, a ticket provider system 140 and a payment processor 170. To begin the process the end-user or group leader interfaces with the ticket provider system to search for an event of interest 122 using keywords, date, geography, etc. in a database 142 that stores a list of events. The group leader reviews the search results and chooses an event 124.

Subsequently, the group leader submits the details of a chosen event 126 to the ticket provider system 140. For example, the group leader may submit preferences such as how notification should occur and/or choose among any available options presented by the ticket provider system. An event record is created at 144 in the ticket provider system database and a list of available tickets for the chosen event is returned to the end-user at 146.

The group leader chooses preferred tickets from the list created from the database and sets ticket and shipping preferences at 128. Billing and shipping information is entered at 130 and via secure connection 148 is sent to the payment processor 160 where payment from the event organizer is authorized 162 and communicated back to the group leader through secure connection 150. At this point, the group leader selects friends to receive invitations to join the group and sets a deadline by which the invited friends must respond at 132. The emails are send to the invited friends at 152 through the ticket provider system whereupon the invited friends indicate their desire to attend and provide billing information at 134 via a secure connection 154 to the payment processor 160 which authorizes the friends' individual payments for tickets at 164. In the ticket provider system, the deadline by which invited friends must reply is detected at 156 whereupon at 158 the tickets are reserved in the database and receipts are issued at 158. Subsequently, payments are charged in the payment processor 170 at 176 and the tickets are queued for shipment or e-delivery at 160 in the ticket provider system.

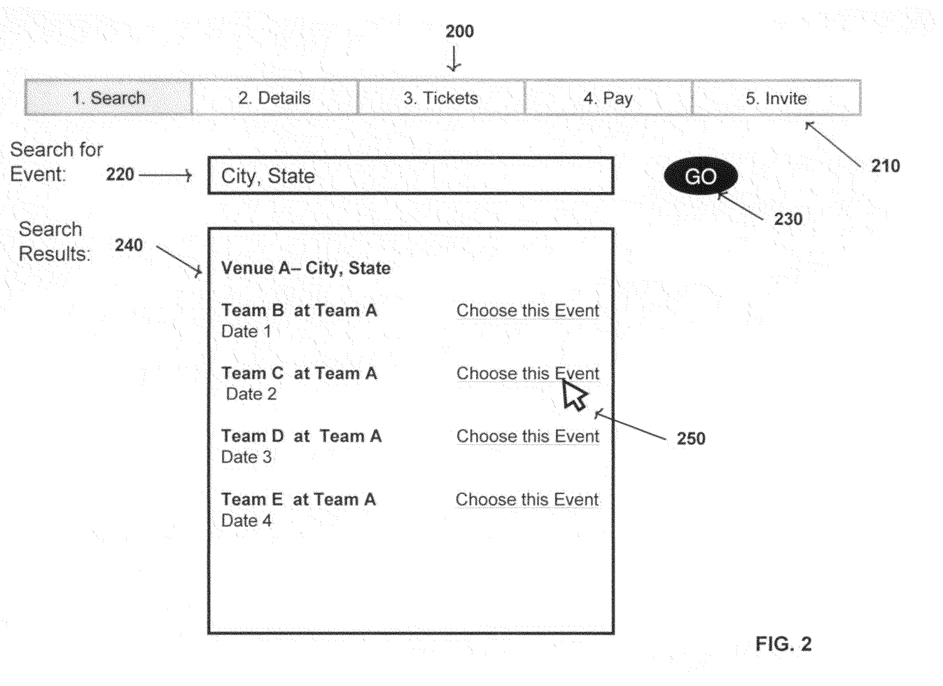

With continued reference to FIG. 1, FIG. 2 depicts a webpage for searching for an event. The group leader views the webpage 200 which displays a bar 210 containing buttons for each of the steps comprising the group ticket purchasing process, i.e., 1. Search, 2. Details, 3. Tickets, 4. Pay, and 5. Invite. To begin the process, the group leader clicks on button 1 to access the webpage 200. The end-user enters a venue at 220 and initiates the search at 230. The search results are displayed at 240. A database 142 of popular events is provided by the website. Typically, secondary market ticket websites maintain an inventory of 30,000 to 80,000 events. The group leader clicks on an event of interest at 250, for example, Team C at Team A on Date 2. Selecting a specific event takes the group leader to the Details window.

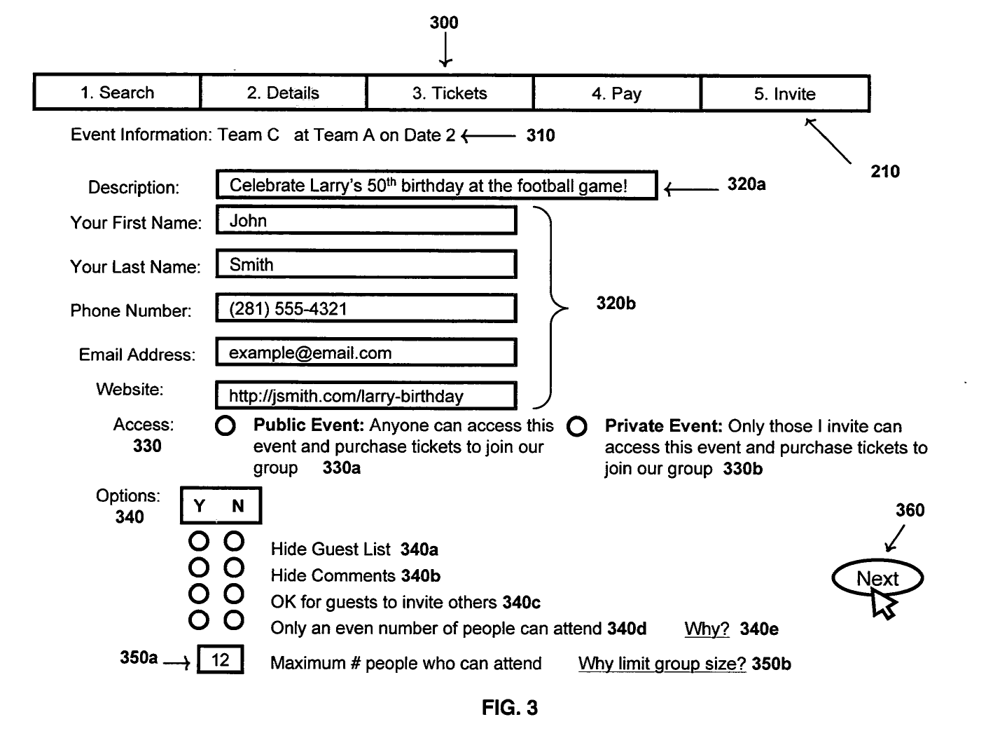

With reference to FIGS. 1-2, FIG. 3 depicts a webpage for entering event details. The group leader views the webpage 300 which displays the bar 210 that identifies the current selected button as 2. Details. The webpage displays the event information at 310 previously selected at 250 from the database. The group leader may enter supplemental information such as a description of or reason for organizing the event at 320a and the group leader's contact information 320b, including first and last names, phone number, email address, and a website address. This information is later used in invitations to email to potential group members as per 132. Optionally, if the group leader would like people who share the same interests to be able to join the event group, access 330 to the event may be made public 330a. Alternatively, access may be private 330b and limited only to those who the group leader invites to purchase tickets and join the group.

The group leader also may select as Yes or No among various options 340, such as, Hide Guest List 340a, Hide Comments 340b, OK for guests to invite others 340c, and only an even number of people can attend 340d. If option 340d is checked as Yes, a link to Why? 340e may be selected which explains that since a majority of tickets in the secondary market are sold only in an even-number of pairings, limiting the group to an even number of attendees ultimately saves the group from splitting the cost of an extra ticket and the potential controversy of deciding what to do with it. The group leader further may indicate the maximum number of attendees at 350a with a link 350b provided as to why the group size is limited.

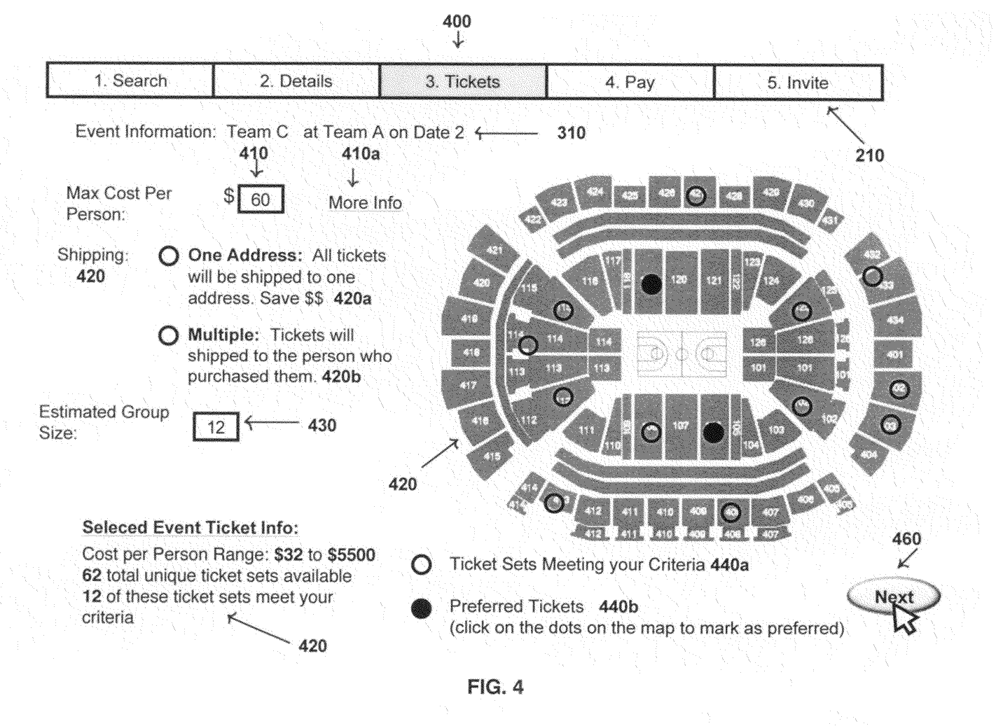

With continued reference to FIGS. 1-3, FIG. 4 depicts a webpage for selecting ticket criteria to fulfill the order with tickets that are most suitable. The group leader views the webpage 400 which displays the bar 210 that identifies the current selected button as 3. Tickets. The webpage displays the event information at 310 previously selected at 250 from the database. The group leader may set a maximum ticket cost 410 to be incurred per attendee. This cost may or may not include all broker fees and shipping costs. The webpage may provide additional information about ticket costs at link 410a. For example, the group leader may choose the Minimum Value Rating for the tickets.

The value rating is an evaluation of price versus the expected experience from sitting in the given seats. The general idea is that each venue is analyzed to identify the relative view from various sections. This view is taken into account as ticket prices are compared, and where available, ticket price is compared to face value. Tickets of the highest value score have a lower price than the tickets around them, most often are on the secondary market for less than face value, and are a “great deal” compared to tickets in other parts of the venue. Value score for each set of tickets is calculated in an automated fashion using a pre-determined equation with custom parameters for each venue. For each seating section in the venue a relative “enjoyment” score is determine based on parameters including but not limited to, physical distance and angle from the stage (stage, playing court, field, etc). This score is applied against the ticket price to compute the value rating.

The group leader indicates shipping preferences at 420, that is, whether to ship all tickets to one address 420a to minimize costs or to multiple addresses belonging to the individuals comprising the group 420b. If the group leader decides to minimize cost, he/she is willing to receive all of the tickets and meet the group ahead of time at the event. If he/she prefers to maximize convenience, each person pays their own shipping and indicates an individual shipping location.

The group leader may indicate an estimated group size at 430 which, optionally, may be identified as a minimum and/or maximum group size. The purpose of limiting group size is to provide the group a higher probability of sitting together. It also gives group members an incentive to RSVP sooner. A minimum group size can be set as well. ‘If group size exceeds the number of qualifying tickets available in any single ticket group, an analysis is performed to determine the two or more sets of qualifying tickets that are nearest geographically in the venue that meet the stated preferences. Groups of 1 or 2 are avoided whenever possible.

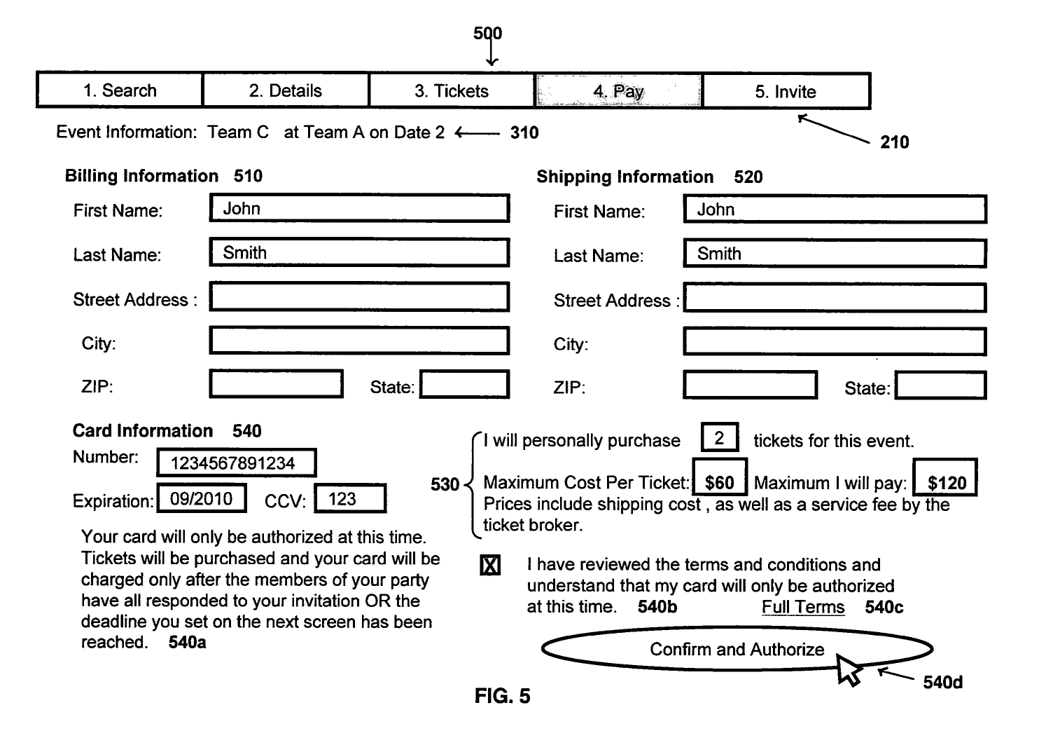

The webpage displays a representation of arena seating 440 for the selected event with available ticket sets meeting the group leader's criteria indicated with an open circle 440a. The group leader may click on the open circles to mark them as preferred ticket sets 440b. A summary of selected event ticket information is summarized and displayed at 450. Additionally, the preferences set by the group leader are passed along to the people invited to the event. The group leader may proceed to the next step by clicking at 460. With continued reference to FIGS. 1-4, FIG. 5 depicts a webpage for paying for the selected tickets. The group leader views the webpage 500 which displays the bar 210 that identifies the current selected button as 4. Pay. The webpage displays the event information at 310 previously selected at 250 from the database. The group leader enters billing information 510 and shipping information 520, each including first and last names, street address, city, state, and zipcode. The group leader also enters payment information 530 indicating the number of tickets personally purchased, the maximum cost per ticket and the maximum cost, including applicable shipping costs and service fees, the group leader will pay. The group leader also provides credit card information 540, including a card authorization statement 540a which the group leader must agree to at 540b. If desired, the group leader may click on the link 540c which discloses full terms of the transaction. The group leader then may click at 540d to confirm and authorize the ticket purchase transaction.

The billing, shipping, payment, and credit card information may or may not be encrypted. Encryption methods are well-known and standard in the art. Also, although the tickets for group members are purchased after the size of the group is known, the group leader is required to have payment authorized at this point in the process. This provides the website assurance that the group is committed to attending the event and that the group agrees to the methods by which tickets are chosen.

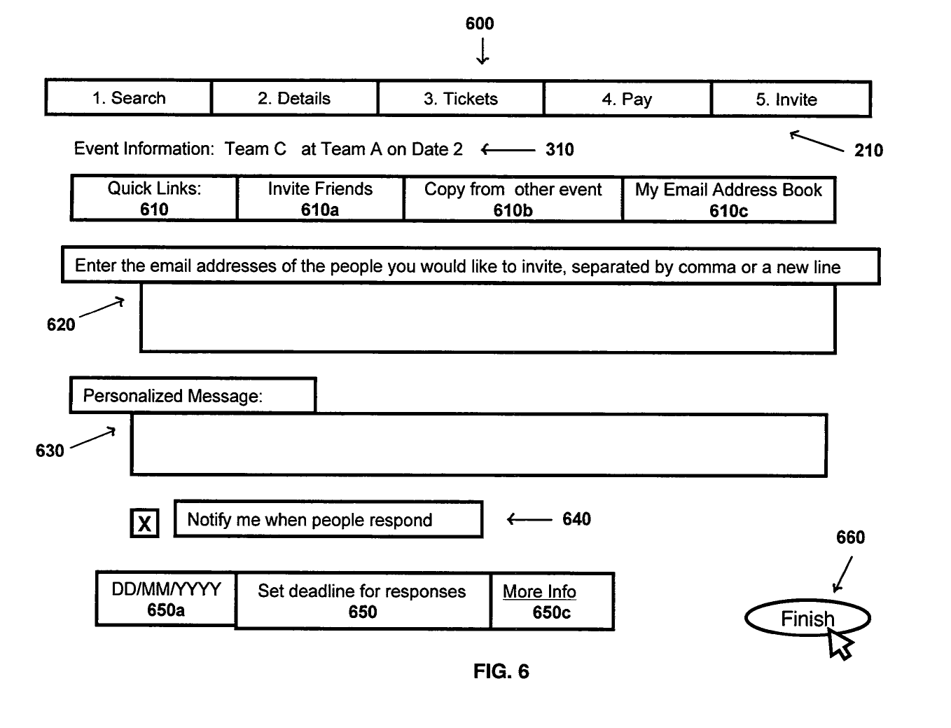

With continued reference to FIGS. 1-5, FIG. 6 depicts a webpage for inviting people to join the group. The group leader views the webpage 600 which displays the bar 210 that identifies the current selected button as 5. Invite. The webpage displays the event information at 310 previously selected at 250 from the database. The group leader optionally may utilize quick links 610 to invite friends 610a, copy information from another event 610b or access his/her email address book 610c. This provides the option of including contacts from the group leader's social network accounts, email address books, previous group events, etc. Alternatively, one or more email addresses are entered manually at 620 and a personalized message may be added at 630. Optionally, the group leader may indicate at 640 that he/she wishes to be notified when people respond to the invitation. In addition, the group leader may enter the date of the email 650a, set the deadline for response 650b or provide a link 650c to more information, such as, but not limited to, details about the event, details regarding group preferences, maximum cost per person, and links to further information, to join the group and to authorize payment, as he/she wishes. When finished, the group leader may send the emails to invited persons by clicking Finish at 660. Furthermore, the persons receiving the invitation may indicate individually whether or not they plan to attend the event with the group with a single click.

If time allows (typically tickets need to be purchased at least 10 days before the event to ensure delivery) the member of the group whose card was unable to be charged receives notification via email. They have a specified time period to update their card or the group's tickets are purchased without them. No ticket review is available. If tickets are not available that meet the group leader's criteria, notification is provided via email and a number of options, including lowering the minimum acceptable value rating, or choosing an event on a different date that is similar to original request. If others have RSVP'd for event and had their payments authorized, they each have the opportunity to bow out if they do not agree with the proposed changes.

The following example(s) are given for the purpose of illustrating various embodiments of the invention and are not meant to limit the present invention in any fashion.

### EXAMPLE 1

### Payment

A Maximum cost per person for attending the event is selected by the group leader as described supra. Cost per person is influenced by several contributing factors. These factors include but are not limited to: Ticket Price; Shipping; and Broker Fees.

For instance, assume the cost per person preference is set to $100. Assume that all attendees agree to have their tickets sent to the group organizer, and that there are 10 attendees. The $20 shipping fee is split among the 10 attendees. Additionally, the broker selling the tickets charges a 10% processing fee in addition to the ticket price. To determine the maximum ticket price that may be selected and still meet the per person ceiling price of $100, the following calculation is made:

$100−$2(Shipping−$20/10 attendees)=$98

(maximum ticket price plus 10% broker fee)=$98÷1.10=$99,

where the maximum ticket price is always rounded down.

The above calculation is made once the invitation deadline has been reached and the group size is known. It is at that point that each attendee's card is charged (each attendee's card has previously been authorized) and the ticket purchase is fulfilled.

### EXAMPLE 2

### Fulfillment Process

Based on the desired implementation, two possible methods could be used (or blended) for ticket fulfillment, i.e., fulfillment based on price and/or fulfillment based on value rating. Regardless of the consumer access point, it is required that the process include integration with an inventory of tickets.

### 1. Fulfillment Criterion Based on Price

When the response deadline is reached on the group ticket invitation, the system automatically selects the tickets that will be purchased from the tickets in the available inventory that meet the group's criteria. After the purchase has occurred, the tickets will be shipped to the each of the users, or to the group leader, based on the group leader's preference.

Minimizing cost vs. maximizing convenience is one function of the way tickets are shipped. When fulfillment is based on price, the system will always purchase the most expensive tickets available with certain quality controls, as long as such tickets are cheaper than the group's maximum ticket price setting. Thus, this provides the best tickets for the amount the group is willing to spend.

### 2. Fulfillment Based on Value Rating

When the response deadline is reached on the group ticket invitation, a decision process goes to work to determine the tickets to purchase from those available in inventory. For the purpose of explaining this automated decision tree, the following inventory of tickets and customer preferences is presented (Table 1). Value score for each set of tickets is calculated in an automated fashion using a pre-determined equation with custom parameters for each venue. For each seating section in the venue a relative “enjoyment” score is determine based on parameters including but not limited to, physical distance and angle from the stage (stage, playing court, field, etc). This score is applied against the ticket price to compute the value rating.

TABLE 1
Available Inventory

| | Cost/person | # Tickets | Value | User |
|---|---|---|---|---|
| Ticket ID | (Price + Fee + Shipping0 | Available | Rating | Preferred ? |
| 101 | 398 | 4 | 9.9 | N |
| 102 | 302 | 6 | 3.4 | N |
| 103 | 310 | 10 | 5.6 | N |
| 104 | 998 | 10 | 8.9 | N |
| 105 | 293 | 8 | 7.4 | Y |
| 106 | 772 | 6 | 6.9 | N |
| 107 | 112 | 10 | 8.2 | Y |
| 108 | 230 | 12 | 7.8 | N |
| 109 | 546 | 10 | 1.2 | N |
| 110 | 223 | 8 | 9.0 | Y |
| 111 | 223 | 10 | 8.0 | Y |
| 112 | 678 | 12 | 7.2 | N |
| 113 | 334 | 8 | 8.3 | Y |
| 114 | 211 | 10 | 8.2 | N |

Table 2 provides an example of a group leader's tickets preferences.

TABLE 2
Group leader Tickets Preferences

| | |
|---|---|
| Max Cost Per Person | 350 |
| Min Value Rating | 8.0 |
| Minimize Cost? | N |
| Maximize Value? | Y |
| Group Size (confirmed) | 8 |

1. The first step is to eliminate tickets that cost more than the limit set by the group leader.

2. The second step is to eliminate all ticket groups that do not have a sufficient number of tickets in them.

3. Eliminate tickets groups below the minimum value rating, unless they were selected as “preferred” by the group leader

In this example, these steps result in the following eliminations (Table 3).

TABLE 3
Eliminations

| Ticket | Cost/person | # Tickets | Value | User Preferred |
|---|---|---|---|---|
| ID | (Price + Fee + Shipping) | Available | Rating | ? |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| [symbol] | [symbol] | [symbol] | [symbol] | [symbol] |
| 105 | 293 | 8 | 7.4 | Y |
| [symbol] | [symbol] | [symbol] | [symbol] | [symbol] |
| 107 | 112 | 10 | 8.2 | Y |
| [symbol] | [symbol] | [symbol] | [symbol] | [symbol] |
| [symbol] | [symbol] | [symbol] | [symbol] | [symbol] |
| 110 | 223 | 8 | 9.0 | Y |
| 111 | 223 | 10 | 8.0 | Y |
| [symbol] | [symbol] | 12 | [symbol] | [symbol] |
| 113 | 334 | 8 | 8.3 | Y |
| 114 | 211 | 10 | 8.2 | N |

So, by the group leader's criteria, the following ticket groups are suitable.

TABLE 4
Post elimination availability

| Ticket | Cost/person | # Tickets | Value | |
|---|---|---|---|---|
| ID | (Price + Fee + Shipping) | Available | Rating | Preferred |
| 105 | 293 | 8 | 7.4 | Y |
| 107 | 112 | 10 | 8.2 | Y |
| 110 | 223 | 8 | 9.0 | Y |
| 111 | 223 | 10 | 8.0 | Y |
| 113 | 334 | 8 | 8.3 | Y |
| 114 | 211 | 10 | 8.2 | N |

To further narrow the results, the following sequence is utilized:
1. Are there preferred and non-preferred tickets remaining? If so, remove the non-preferred.
2. Does the group leader wish to minimize cost? If YES, then choose the remaining ticket group with the lowest cost per person. If NO, continue to the next step.
3. The maximum value rating from the remaining ticket groups is chosen.

TABLE 5
Final selection

| | Cost/person | # Tickets | Value | |
|---|---|---|---|---|
| Ticket ID | (Price + Fee + Shipping) | Available | Rating | Preferred |
| 110 | 223 | 8 | 9.0 | Y |

The resulting tickets are purchased and shipped according to the group leader's shipping preferences. All group member are charged their portion of the cost, and payment processed.

One skilled in the art will readily appreciate that the present invention is well adapted to carry out the objects and obtain the ends and advantages mentioned, as well as those inherent therein. It will be apparent to those-skilled in the art that various modifications and variations can be made in practicing the present invention without departing from the spirit or scope of the invention. Changes therein and other uses will occur to those skilled in the art which are encompassed within the spirit of the invention as defined by the scope of the claims.

What is claimed is:

1. A method of providing group tickets to an event of interest, comprising:
selecting an event of interest;
screening an inventory of seats for the event to create a list of available tickets;
choosing from the list of available tickets, tickets that meet a set of predetermined criteria; and
processing the purchase of one or more group tickets by each group member, using information supplied by said group member.

2. The method of claim 1, wherein said predetermined criteria are a smallest group size and largest acceptable group size.

3. The method of claim 1, wherein said predetermined criteria is a maximum acceptable price of each ticket in the group.

4. The method of claim 3, wherein said maximum acceptable price is inclusive of broker fees and shipping costs.

5. The method for claim 1, wherein said predetermined criteria is a specified lowest acceptable value parameter for each ticket.

6. The method of claim 5, wherein the value parameter is a number between 1 and 10, such that a value parameter of 10 depicts the highest expected enjoyment value based on the price of the ticket, the nature of the event, and spatial relationship of the seat to the event, e.g., to the center of the stage or playing field, etc.

7. The method of claim 1, wherein said predetermined criteria are assigned by a group leader.

8. The method of claim 7, wherein said group leader further assigns an attitude toward the ticket purchase based on optimal price and optimal value.

9. The method of claim 1, wherein group membership is restricted and only accessible to individuals invited by a group leader.

10. The method of claim 1, wherein said group tickets are assigned seats adjacent to one another.

11. The method of claim 1, wherein said group tickets are assigned seats in geographical vicinity, though not adjacent to one another.

12. The method of claim 1, wherein the user information is encrypted.

13. The method of claim 1, wherein group-tickets are shipped to a group leader.

14. The method of claim 1, wherein group tickets are shipped to individual group members.

15. A system for providing group-tickets to an event of interest, comprising:
a processor;
a port coupled to the processor;
a memory, coupled to the processor, storing instructions adapted to be executed by the processor to:
selecting an event of interest; screening an inventory of seats for the event to create a list of available tickets; choosing from the list, tickets that meet a set of predetermined criteria; and processing the purchase of one or more group tickets by each group member, using information supplied by said group member.

16. The system according to claim 15, wherein said predetermined criteria are:
a smallest and largest acceptable group size;
a maximum acceptable price of each ticket in the group;
and a specified lowest acceptable value parameter for each ticket.

17. The system according to claim 16, wherein the value parameter is a number between 1 and 10, such that a value parameter of 10 depicts the highest expected enjoyment value based on the price of the ticket and the nature of the event.

18. A computer-readable medium that stores instructions for providing group-tickets to an event of interest, the instructions adapted to be executed by a processor to perform the steps of:
selecting an event of interest;
screening an inventory of seats for the event to create a list of available tickets;
choosing from the list, tickets that meet a set of predetermined criteria; and
processing the purchase of one or more group tickets by each group member, using information supplied by said group member.

19. The computer-readable medium of claim 18, wherein said predetermined criteria are:
a smallest and largest acceptable group size;
a maximum acceptable price of each ticket in the group;
and a specified lowest acceptable value parameter for each ticket.

20. The computer-readable medium of claim 18, wherein the value parameter is a number between 1 and 10, such that a value parameter of 10 depicts the highest expected enjoyment value based on the price of the ticket and the nature of the event.
